(19) United States
(12) Patent Application Publication
(10) Pub. No.: US 2025/0207724 A1
(43) Pub. Date: Jun. 26, 2025

(54) METHOD FOR MONITORING THE CONDITION OF LUBRICATING OIL OF INDUSTRIAL EQUIPMENT AND SYSTEM FOR MONITORING THE CONDITION OF LUBRICATING OIL OF INDUSTRIAL EQUIPMENT

(71) Applicants: PETRÓLEO BRASILEIRO S.A. - PETROBRAS, Rio de Janeiro (BR); AA LINHARES COMERCIO E SERVIÇOS EIRELI, Rio das Ostras (BR)

(72) Inventors: RONALDO LUCAS ALKMIN FREIRE, São José dos Campos (BR); FRANCISCO GABRIEL ISOPPO LISBOA, Rio das Ostras (BR); ALEXANDRE ALBERNAZ LINHARES, Rio das Ostras (BR); DOUGLAS DE PAULA SANTOS, Santos (BR); ANTÔNIO BATISTA RIBEIRO NETO, Rio das Ostras (BR); CHARLES LIMA BESSA ASSUNCAO, Rio de Janeiro (BR); DOUGLAS BARBONAGLIA SATHLER FIGUEIREDO, Rio das Ostras (BR)

(73) Assignees: PETRÓLEO BRASILEIRO S.A. - PETROBRAS, Rio de Janeiro (BR); AA LINHARES COMERCIO E SERVIÇOS EIRELI, Rio das Ostras (BR)

(21) Appl. No.: 18/989,933

(22) Filed: Dec. 20, 2024

(30) Foreign Application Priority Data
Dec. 22, 2023 (BR) 1020230272290

(51) Int. Cl. F16N 29/00; F16N 39/06

(52) U.S. Cl. CPC F16N 29/00; F16N 39/06; F16N 2200/04; F16N 2200/10; F16N 2200/12; F16N 2200/20; F16N 2230/02; F16N 2250/04; F16N 2250/08; F16N 2250/18; F16N 2250/34; F16N 2250/40

(57) ABSTRACT

The present invention relates to a method for monitoring the condition of lubricating oil of industrial equipment, a system for monitoring the condition of lubricating oil of industrial equipment, a panel for monitoring the condition of lubricating oil of industrial equipment for classified or non-classified area, and a computer-readable storage medium.

### CROSS-REFERENCE TO RELATED APPLICATIONS

This application claims priority to Brazilian Application No. BR 1020230272290, filed on Dec. 22, 2023, the disclosure of which is herein incorporated by reference in the entirety.

### FIELD OF THE INVENTION

The present invention falls within the technical field of predicting failures in industrial equipment. In particular, the present invention relates to a method for monitoring the condition of lubricating oil in industrial equipment, a system for monitoring the condition of lubricating oil in industrial equipment, a panel for monitoring the condition of lubricating oil in industrial equipment for classified or non-classified areas, and a computer-readable storage medium.

### BACKGROUND OF THE INVENTION

Predictive analysis of the condition of lubricating oil in mechanical equipment is a well-established technique in the industry that allows not only to effectively monitor the health condition of the equipment, but also to anticipate deviations and premature wear, allowing actions to be taken to preserve the mechanical integrity of the equipment, avoiding downtime and production losses.

The strategic frequency of performing predictive analyses of the condition of lubricating oil has a great influence on the potential for monitoring the health condition of the equipment for the proactive mitigation of unscheduled shutdowns, since the operator makes decisions based on the data collected in these analyses.

In the current scenario, the process of analyzing the condition of lubricating oil can be performed in a laboratory or through sensors.

For mechanical equipment installed on oil platforms, as well as in other difficult-to-access locations such as wind turbines, predictive oil analysis in the laboratory has limitations. The time consumed from the manual collection of the oil sample to the analysis of the report received from the laboratory causes delays in the process of diagnosing anomalies.

In addition, the influence of human factors in the handling of oil samples can result in erroneous results due to contamination.

Finally, the sample collection process exposes workers to the various risks present in industrial areas and costs associated with the logistics of accessing the equipment.

The use of oil sensors, with or without association with data analysis software, can help reduce the limitations imposed by predictive oil analysis in the laboratory. However, this approach is still not sufficient to anticipate operating conditions that are potentially harmful to the mechanical integrity of the equipment, prior to the perception of a deviation in oil quality. This is due to the fact that the operation of mechanical equipment under certain conditions can result, for example, in greater or lesser generation of heat and mechanical stress, resulting in the consumption, at a greater or lesser rate, of its useful life.

Furthermore, the oil sensors available on the market are not capable of measuring all the physical and chemical parameters of the oil, as verified in predictive maintenance, and do not generate results comparable to those obtained through laboratory tests. The lack of integration between the oil condition data obtained through sensors and the data from predictive analyses in the laboratory can result in divergent interpretations, both by artificial intelligence algorithms and by predictive maintenance teams. In other words, the possibility of the oil sensor, with or without association with data analysis software, presenting a diagnosis and prescribing a corrective action different from that obtained through predictive analysis in the laboratory, can represent a risk to the integrity of mechanical equipment.

### STATE OF THE ART

In many companies, predictive analysis of the condition of lubricating oil or control of mechanical equipment involves only the manual collection of oil samples from the equipment and sending them for analysis in laboratories, which perform tests in accordance with international standards.

The results of the analyses are made available by the laboratory to the predictive maintenance teams in the form of documents (reports), including information on the current analysis and a history of the latest analyses. In addition, opinions are shown on the information found individually for each test performed.

The process of manually collecting oil samples is subject to contamination and the cost of collecting and transporting them, especially in mechanical equipment installed in remote areas, such as offshore oil and gas production platforms and wind turbines.

The chain of processes from collecting the oil sample in the mechanical equipment to analyzing the report provided by the laboratory is too time-consuming, which compromises the overall result of predictive monitoring, the purpose of which is to anticipate anomalies before mechanical failures occur, with or without compromising the operational availability of the equipment.

The analysis of oil parameters alone limits the diagnostic capacity, since correlation with machine parameters is necessary for a more complete overview of the health of the equipment.

These limitations highlight the need for a more agile, accurate and integrated approach to monitoring and diagnosing failures in industrial machinery and equipment.

Recently, some companies have begun to complement or replace predictive laboratory oil analysis with new sensors dedicated to measuring the physical and chemical parameters of the oil, with or without association with data analysis software, allowing the anticipation of anomalies associated with the deterioration of oil quality and that could cause mechanical equipment to fail.

However, this approach still has limitations, especially in relation to its ability to anticipate operating conditions that are potentially harmful to the integrity of mechanical equipment, before deviations in oil quality are noticed. This is because the operation of mechanical equipment under certain conditions can result, for example, in greater or lesser generation of heat and mechanical stress, resulting in the consumption, at a greater or lesser rate, of its useful life.

The oil sensors available on the market are not capable of measuring all the physical-chemical parameters of the oil verified in predictive maintenance and generating comparable results with the same quality as those generated in laboratory analyses.

Therefore, with the lack of interchangeability between methods, it is of utmost importance to integrate the process of analyzing the oil condition data obtained through these new sensors and predictive analyses in the laboratory.

The absence of this integration may result in divergent interpretations, both by algorithms using artificial intelligence operating in isolation, and analytically by operation and maintenance teams, which may result in both inadequate prescriptions and the absence of prescriptions for actions aimed at protecting the integrity and maximizing the operational availability of mechanical equipment.

The document CN 102707037 B, entitled “On-line monitoring system for diesel lubrication oil” describes an online monitoring system for lubrication oil that continuously monitors the condition of the oil and provides real-time alerts about potential problems. The system overcomes the limitations of laboratory-based monitoring methods, which are prone to errors and delays. The online system uses multiple sensors to collect comprehensive information about the condition of the oil, resulting in more accurate monitoring and diagnosis. The main features of the invention include real-time and continuous monitoring of lubricating oil, a failure warning system to detect potential problems early, synchronous monitoring with the operating status of the diesel engine, elimination of delays and errors associated with manual collection of samples for laboratory analysis, and more accurate monitoring and diagnosis using multiple sensors. Overall, this invention provides a valuable tool for ensuring proper lubrication and maintenance of diesel engines.

The main contrasts between the patent document mentioned above and the present invention are in the focus and use of the Artificial Intelligence (AI) system. The patent CN 102707037 B was developed to monitor diesel engines, without the use of an AI tool to interpret the data obtained from the sensing. The present invention, using AI, allows the proposed system to accurately identify the presence and concentration of contaminants, assess machine wear, and determine the need for oil change or treatment. However, the installation of the system in an area at risk of explosion is possible thanks to the use of pressurized panels that ensure adequate safety. Advanced communication resources allow information on oil quality to be monitored and accessed remotely, enabling supervision and analysis of data by professionals responsible for maintenance and management of the equipment.

In general, the system and method of the present invention have a series of improvements in relation to the system previously described. The use of AI, the installation in an area at risk of explosion (classified area) and the advanced communication resources make the proposed system more accurate, safe and efficient, which can result in a series of benefits for users, such as reduced maintenance costs, increased equipment lifespan and improved safety.

The “Oil properties diagnostic system for work machine” described in the document U.S. Ser. No. 10/087,605 B2 is an oil properties diagnostic system for work machines, which comprises a data storage device in which sensor information from a sensor that detects a property of the oil used for the operation of the work machine and a value for determining the degree of abnormality defined for each type of sensor information are stored, and an arithmetic processing device that performs the first processing of discriminating the degree of abnormality level of the oil based on the sensor information and the value for determining the degree of abnormality level, the second processing of determining whether or not there is a need to perform oil analysis involving oil extraction based on the degree of abnormality level of the oil discriminated in the first processing, and the third processing of outputting information indicating that oil analysis is necessary to another terminal if it is determined that oil analysis is necessary in the second processing.

Briefly, the system monitors the properties of the oil used in a work machine and determines whether additional oil analysis is required. The system stores sensor information about the oil properties and compares them with defined abnormality degree determination values. If the oil abnormality degree exceeds a certain limit, the system will output information indicating that oil analysis is required. This system can help prevent failures in work machines caused by oil problems.

The main difference between the system described in the patent document U.S. Ser. No. 10/087,605 B2 and the present invention is the use of an AI interface for analysis and diagnosis of anomalies, as well as the possibility of inputting oil quality values obtained from laboratory analysis, not only based on the sensing of the monitored equipment. The oil property diagnosis system for work machines of said document from the state of the art, on the other hand, uses defined abnormality degree determination values to compare sensor information to oil properties. This can lead to diagnostic errors, especially if the oil is in an abnormal state that is not predicted by the abnormality degree determination values. Another difference is that the system of the present invention can be installed in an area at risk of explosion (classified area). This is possible thanks to the use of pressurized panels that ensure adequate safety. The oil property diagnostic system for working machines from the state of the art, on the other hand, cannot be installed in classified areas.

Finally, the system of the present invention has advanced communication features suitable for remote areas. This allows information on oil quality to be monitored and accessed remotely, enabling supervision and analysis of data by professionals responsible for maintenance and management of equipment. The oil property diagnostic system for work machines from the state of the art, on the other hand, does not have advanced communication features.

In general, the proposed system has a series of improvements in relation to the oil property diagnostic system for work machines described in the patent document above. The use of artificial intelligence, installation in a classified or non-classified area and advanced communication features make the system of the present invention more accurate, safe and efficient for use in large machines operating in classified areas.

The document U.S. Ser. No. 11/029,680 B2, “Methods and systems for detection in an industrial internet of things data collection environment with frequency band adjustments for diagnosing oil and gas production equipment”, describes a system for monitoring oil and gas production equipment. The system includes a data collector connected to a plurality of input channels. The input channels are connected to data collection points that are operatively coupled to at least one of the oil or gas production components. The system also includes a data storage unit that stores a plurality of diagnostic frequency bands for at least one of the oil or gas production components. A data acquisition circuit interprets a plurality of detection values from the input channels. A data analysis circuit analyzes the plurality of detection values to determine measured frequency band data and compares the measured frequency band data to the diagnostic frequency bands and diagnoses an operational parameter of the at least one of the oil or gas production components in response to the comparison.

The present invention also describes a system for monitoring oil and gas production equipment. However, the AI system for analyzing and diagnosing anomalies makes it possible to prevent premature equipment failures. Nevertheless, the system of the present invention can be installed in an area at risk of explosion (classified area). This is possible thanks to the use of pressurized panels that ensure adequate safety, in addition to having advanced communication resources, using a wireless network and the possibility of inserting information from laboratory reports into the models. This allows information on oil quality to be monitored and accessed remotely, enabling supervision and analysis of data by professionals responsible for maintenance and management of the equipment.

The patent EP 4137815 A1 relates to monitoring the condition of hydraulic oil in industrial equipment, using an oil sensor and a parameter calculation system to predict failures in this equipment based on oil data, with a focus on oil monitoring and predicting failures based on oil parameters.

On the other hand, the present invention is a more comprehensive innovation that goes beyond simple oil monitoring. The present invention uses a pressurized panel with high-precision oil sensors, powered by artificial intelligence and machine learning, to monitor oil quality in real time, identify contaminants, assess machine wear, and offer the flexibility to incorporate multiple sensors for a complete view of machine condition. This project also stands out for its efficient communication capability and intuitive interface for data analysis.

Regarding the document U.S. Pat. No. 9,303,540 B2, Turbomachine Lubricating oil analyzer apparatus, it describes a device for monitoring lubricating oil in an oil reservoir of a turbomachine. The device consists of a housing section that includes a box, a base plate, and a rear support coupled to the box. An oil inlet duct extends through the base plate, fluidly connecting with the turbomachine oil reservoir. A pump is fluidly connected to the oil inlet duct, as well as an oil analyzer, and a drain duct extending through the base plate is fluidly connected to the oil analyzer. In addition, the device has a bracket coupled to the housing section for connection to the turbomachine oil reservoir.

Compared to the present invention, the design of U.S. Pat. No. 9,303,540 B2 shows a more specific and focused approach, directed exclusively to the monitoring of lubricating oil in turbomachine reservoirs. While the present invention offers a more comprehensive solution, which includes continuous monitoring, real-time diagnostics, contaminant detection, evaluation of machine wear and flexibility for different sensors. Document U.S. Pat. No. 9,303,540 B2 focuses, specifically, on the analysis of lubricating oil in machines of this type. The present invention is more versatile and applicable to a variety of oil monitoring scenarios, while U.S. Pat. No. 9,303,540 B2 meets the specific needs of turbomachine monitoring.

The document Unsupervised Learning approach for predictive maintenance in power transformers, by Duarte Miguel de Novo Faria (https://hdl.handle.net/10216/140744) does not disclose any information about lubricating oils, since, as these are electrical transformers, the oil used is intended for thermal insulation (cooling). Therefore, this document does not show a solution to the technical problem of real-time monitoring of the condition of lubricating oils, such as the present invention. This document outlined a methodology to deal with the growing challenge of analyzing large volumes of unlabeled data related to monitoring in large machines, such as transformers. Using clustering algorithms such as DBSCAN and K-Means, it allowed the effective categorization of this data, providing labels and making it possible to identify patterns and anomalies. This is of utmost importance for the industrial sector, as it enables the early detection of potential problems with oil quality, machine wear and contaminants, allowing proactive action.

### BRIEF DESCRIPTION OF THE INVENTION

The objective of the invention is to provide a method and a system composed of software and hardware, capable of monitoring the health of industrial equipment, such as mechanical equipment, issuing alerts about anomalies and predicting the time in which the equipment will be able to operate until it fails, considering an integrated approach to data analysis of predictive analyses of oil samples in the laboratory, monitoring of physical-chemical parameters of the oil through oil sensors and other information from various sensors of mechanical equipment and industrial plants, such as: rotation, temperature, pressure, flow, electric current, voltage, power, vibration and position sensors.

Furthermore, one of the differentials of the present invention is the integrated analysis of the operational condition and predictive monitoring of mechanical equipment, enabling the training of algorithms with artificial intelligence to recognize patterns associated with anomalies. Some patterns could not be identified by other systems and methods from the state of the art due to the lack of a data lake integrating information from different sources.

Another distinguishing feature of this invention is the estimation of the service life of mechanical equipment until its failure, including new anomaly patterns obtained from the integration of data from different sources.

Therefore, in relation to previous inventions, the present invention provides a more comprehensive and integrated characterization of operational and predictive maintenance aspects necessary for the correct understanding of patterns that can cause mechanical equipment to fail. In this way, it is possible to anticipate even more actions in order to preserve the useful life of the equipment, maximizing its operational availability.

It is worth noting that the present invention covers different types and amounts of oil sensors, combining different physical-chemical monitoring parameters according to the characteristics of each mechanical equipment and selection of parameters for predictive monitoring of the condition of the lubricating or control oil.

According to a preferred embodiment of the present invention, a method is defined for monitoring the condition of the lubricating oil of industrial equipment, comprising the steps of:
obtaining a plurality of equipment data, a plurality of oil quality data and a plurality of data from the laboratory result of analysis of the lubricating oil of the equipment;
identifying a current state of the equipment, wherein the current state of the equipment includes one of: off, on, turning on or turning off;
if the current state of the equipment is other than off, identifying the operational condition of the equipment, wherein the operational condition of the equipment includes one of: normal, satisfactory, unsatisfactory or unacceptable;
wherein the operational condition of the equipment is identified through a second tool to identify the operational condition of the equipment, using the DBSCAN (Density-Based Spatial Clustering of Applications with Noise) tool, creating data groups from the plurality of oil quality data wherein the data groups represent the operational condition of the equipment: normal, satisfactory, unsatisfactory or unacceptable;
feeding equipment operating condition data sets into a machine learning classification model for predicting the condition of lubricating oil of industrial equipment;
the plurality of equipment data is obtained through at least one equipment sensor, wherein the plurality of equipment data comprises:
actual opening data of the guide vanes,
engine power,
power on the output shaft of the equipment,
torque on the output shaft,
rotation of the output shaft,
rotation of the input shaft,
working oil level of the equipment,
working oil level of the vorecon,
pressure differential of lubricating oil filter,
header pressure of the lubricating oil,
pressure after the filter of the lubricating oil,
pressure after the pump of the lubricating oil,
working oil temperature after the exchanger,
lubricating oil temperature after the exchanger,
lubricating oil temperature downstream of the exchanger,
lubricating oil temperature in the tank,
working oil temperature of the torque converter equipment,
working oil temperature downstream of the torque converter,
water detector in the equipment,
radial vibration x of the input shaft of the equipment,
radial vibration y of the input shaft of the equipment,
radial vibration x of the intermediate shaft of the equipment,
radial vibration y of the intermediate shaft of the equipment,
radial vibration x of the output shaft of the equipment,
radial vibration y of the output shaft of the equipment,
vibration of the casing on the low-speed side of the equipment,
vibration of the equipment on the high-speed side of the equipment,
axial displacement 1 of the input shaft of the equipment, and
axial displacement 2 of the input shaft of the equipment.

Furthermore, the current state of the equipment is identified through a first tool for identifying the current state of the equipment (5.1), which uses the dimensionality reduction tool by principal components (PCA, Principal Component Analysis) on the plurality of equipment data.

The plurality of oil quality data is obtained through a plurality of oil quality sensors, wherein the plurality of oil quality data comprises:
Moisture,
Density,
Viscosity,
Dielectric constant,
Water activity and temperature,
Density at 20° C.,
Kinematic viscosity,
Viscosity index,
Viscosity at 40° C.,
Viscosity at 100° C.,
Particles in fluids (particle analysis),
Particle morphology,
Presence of varnish,
Degradation of fluid due to opacity (level of coloration),
Presence of water bubbles,
Presence of air bubbles,
Classification of particles present in the oil (ISO 4406 and NAS 1638), and
SAE AS 4059 (evaluates the level of contamination by counting particles in 100 ml, by referencing).

The operating condition of the equipment is identified through the second tool to identify the operating condition of the equipment, using the DBSCAN (Density-Based Spatial Clustering of Applications with Noise) tool, creating data groups from the plurality of data from the laboratory result of analysis of the lubricating oil of the equipment, wherein the data groups represent the operating condition of the equipment: normal, satisfactory, unsatisfactory or unacceptable.

Furthermore, according to another preferred embodiment of the present invention, a system for monitoring the condition of the lubricating oil of industrial equipment is defined, comprising:
at least one equipment sensor;
a plurality of oil quality sensors;
at least one data forwarding means;
at least one storage means;
at least one application server; and
at least one display means;
wherein the at least one application server comprises a first tool for identifying the current state of the equipment and a second tool for identifying the operational condition of the equipment;
wherein the at least one application server predicts the condition of the lubricating oil of industrial equipment.

The at least one equipment sensor provides a plurality of equipment sensor data, comprising:
actual opening data of the guide vanes,
engine power,
power on the output shaft of the equipment,
torque of the output shaft,
rotation of the output shaft,
rotation of the input shaft,
working oil level of the equipment,
working oil level of the vorecon,
differential of the filter pressure of the lubricating oil,
header pressure of the lubricating oil,
pressure of the lubricating oil after filter,
pressure of the lubricating oil after pump,
temperature of the working oil after exchanger,
temperature of the lubricating oil after exchanger,
temperature of the lubricating oil downstream of exchanger,
temperature of the lubricating oil in tank,
working temperature of the oil of the torque converter equipment,
temperature of the working oil downstream of the torque converter,
water detector in the equipment,
radial vibration x of the input shaft of the equipment,
radial vibration y of the input shaft of the equipment,
radial vibration x of the intermediate shaft of the equipment,
radial vibration y of the intermediate shaft of the equipment,
radial vibration x of the output shaft of the equipment,
radial vibration y of the output shaft of the equipment,
vibration of the casing on the low-speed side of the equipment,
vibration of the equipment on the high-speed side of the equipment,
axial displacement 1 of the input shaft of the equipment, and
axial displacement 2 of the input shaft of the equipment.

The plurality of oil quality sensors provide a plurality of oil quality data comprising:
Moisture
Density
Viscosity
Dielectric constant
Water activity and temperature
Density at 20° C.
Kinematic viscosity
Viscosity index
Viscosity at 40° C.
Viscosity at 100° C.
Particles in fluids (particle analysis)
Particle morphology
Presence of varnish
Degradation of fluid by opacity (level of coloration)
Presence of water bubbles
Presence of air bubbles
Classification of particles present in the oil (ISO 4406 and NAS 1638) and
SAE AS 4059 (by referencing).

The at least one data forwarding means comprises at least one router that aggregates data from the at least one equipment sensor and data from the plurality of oil quality sensors and forwards them to the at least one storage means.

The at least one storage means receives a plurality of data from the laboratory result of analysis of the lubricating oil of the equipment, a plurality of equipment sensor data and a plurality of oil quality data.

The at least one application server comprises a first tool for identifying the current state of the equipment and a second tool for identifying the operational condition of the equipment.

The first tool identifies the current state of the equipment, using the principal component analysis (PCA) tool on a plurality of equipment data, wherein the current state of the equipment comprises: off, on, turning on or turning off.

The second tool for identifying the operating condition of the equipment identifies an operating condition of the equipment using the DBSCAN (Density-Based Spatial Clustering of Applications with Noise) tool by creating data groups from a plurality of data from the laboratory result of analysis of the lubricating oil of the equipment, wherein the data groups represent the operating condition of the equipment: normal, satisfactory, unsatisfactory or unacceptable.

At least one application server performs a prediction of the condition of the lubricating oil of industrial equipment by feeding the groups of data of the operating condition of the equipment into a machine learning classification model for predicting the condition of the lubricating oil of industrial equipment.

Complementarily, according to an additional preferred embodiment of the present invention, a panel for monitoring the condition of the lubricating oil of industrial equipment is defined, characterized by comprising:
at least one filter,
at least one first sensor,
at least one second sensor,
at least one outlet register,
at least one hydraulic pipe,
wherein the lubricating oil of the industrial equipment enters the at least one filter and, through the at least one hydraulic pipe, passes through the first sensor and the second sensor, up to the at least one outlet register and returns to the industrial equipment;
the data generated by the first sensor and the second sensor are transmitted via the at least one router to a data server, which stores a set of instructions for performing the method for monitoring the condition of the lubricating oil of industrial equipment.

The panel is arranged in at least one casing.

Alternatively, the panel is arranged in at least one casing, wherein the panel is pressurized through at least one pressurizing unit and at least one purge valve;
wherein the casing comprises at least one vortex air inlet, at least one vortex and at least one actuating solenoid, which is connected to at least one source via a plurality of power cables;
wherein the actuating solenoid is actuated by at least one thermostat, upon identifying an increase in internal temperature of the at least one casing.

The casing further comprises at least one cover, which includes at least one display; at least one light indicator, at least one emergency button, at least one router reset button.

Furthermore, the panel additionally comprises at least one main switch arranged on the outside of the at least one casing, wherein the at least one main switch is connected via at least one electrical cable to at least one input circuit breaker, which is connected to the at least one phase A surge protector and at least one phase B surge protector, which are connected to the at least one source.

The at least one source is connected to the at least one first sensor, the at least one second sensor, the at least one router, via a plurality of power cables.

The data generated by the first sensor and the second sensor are transmitted via the at least one router through at least one data cable, in at least one channel.

The panel further comprises at least one input register for regulating the passage of the lubricating oil through the at least one hydraulic pipe, at least one fuse connected to the at least one first sensor, to the at least one second sensor; at least one antenna, wherein at least one cable of the antenna connects to the at least one router; and at least one grounding connector.

The panel further comprises at least one input register for regulating the passage of the lubricating oil through the at least one hydraulic pipe, at least one fuse connected to the at least one first sensor, to the at least one second sensor and to at least one thermostat; at least one sealing unit with at least one antenna connected thereto, wherein the at least one cable of the antenna connects to the at least one router; and at least one grounding connector.

In addition, the present invention defines, according to another preferred embodiment thereof, a computer-readable storage medium, characterized by comprising, stored therein, a set of computer-readable instructions, which, when executed by a computer, execute the method for monitoring the condition of the lubricating oil of industrial equipment.

### BRIEF DESCRIPTION OF THE FIGURES

In order to complement the present description and obtain a better understanding of the characteristics of the present invention, and according to a preferred embodiment thereof, a set of figures is shown in the annex, where its preferred embodiment is represented in an exemplary, although not limitative, manner.

FIG. 1 shows a graph that illustrates the result of failure identification.

FIG. 2 shows a graph that illustrates the result of failure identification in a single piece of equipment.

FIG. 3 represents a diagram of the system for monitoring the condition of the lubricating oil of industrial equipment.

FIG. 4 shows a panel for monitoring the condition of lubricating oil in industrial equipment for a classified area.

FIG. 5 shows a panel for monitoring the condition of lubricating oil in industrial equipment for a non-classified area.

### DETAILED DESCRIPTION OF THE INVENTION

The method for monitoring the condition of lubricating oil in industrial equipment and the system for monitoring the condition of lubricating oil in industrial equipment of the present invention efficiently solve the problem of inefficient and inaccurate monitoring of oil quality.

Specifically, the traditional approach, based on fixed intervals or periodic laboratory analyses, was replaced by the system for monitoring the condition of lubricating oil in industrial equipment, which comprises a pressurized panel with oil sensors.

More specifically, the system performs real-time monitoring of the oil condition, using artificial intelligence to analyze and diagnose anomalies.

This advanced approach to the method and system of the present invention allows for the accurate identification of the presence and concentration of contaminants, evaluation of machine wear and determination of the need for oil change or treatment. In this way, damage to machines, equipment and hydraulic units has been reduced, maintenance costs have been optimized and the useful life of the equipment has been extended.

In addition, the system can comprise a pressurized panel for installation in an area at risk of explosion (classified area). This panel ensures adequate safety, preventing the spread of flames or explosions to the surrounding environment. In this way, industrial facilities, such as refineries, chemical or petrochemical industries, are protected against the risk of fire and explosions, providing safety for both the facilities and the workers.

Additionally, the system has advanced communication capabilities, using a wireless network, which allows a reliable and fast connection, facilitating the transmission of data collected by the sensors in real time. With this efficient communication capability, information on oil quality can be monitored and accessed remotely, enabling the supervision and analysis of data by professionals responsible for maintenance and management of the equipment. This results in more assertive and timely decisions regarding preventive maintenance, optimizing the performance of machines, equipment and hydraulic units and significantly reducing downtime.

More specifically, the method, system and panel of the present invention use an Artificial Intelligence (AI) and Machine Learning (ML) tool, integrated with sensors, such as OilWear sensors from Atten2 Advanced Monitoring Technologies and YTS61 6-in-1 from Yateks or any other sensor available on the market or any other sensor complementary to these two mentioned, depending on the application. These sensors can be used to collect a variety of oil quality data, including contaminant concentration, viscosity index, temperature and pressure, predicting the future quality of the monitored oil.

The YTS61 6-in-1 sensor is capable of measuring moisture (ppm), density (kg m-3), viscosity, dielectric constant, water activity and oil temperature. Using piezoelectric resonant MEMS components and an integrated high-precision signal sampling and processing unit, along with advanced algorithms, the YTS can automatically detect:
Moisture
Density
Viscosity
Dielectric constant
Water activity and temperature
Density at 20° C.
Kinematic viscosity
Viscosity index
Viscosity at 40° C.
Viscosity at 100° C.

The OilWear sensor is a sensor based on real-time fluid image analysis, specialized in identifying particles and bubbles up to 4 μm. It operates optically: a light is directed at the fluid circulating internally in the sensor, capturing images of the particles. These are analyzed by artificial intelligence that counts and identifies each particle. The sensor is capable of discerning the morphology of the particles, indicating, through analysis, the possible root cause of problems in the machine wherein the fluid is in use. It can also determine the degradation of the fluid by opacity, identifying color variations. Through artificial intelligence, the sensor informs the level of degradation of the fluid. One of its attributes is to detect the presence of varnish in significant amounts. When varnish particles are identified as unclassified, and the level of degradation begins to increase, it is understood that varnish is forming in the machine. This sensor provides the following data:
Particles in fluids (particle analysis)
Particle morphology
Presence of varnish
Degradation of fluid due to opacity (level of coloration)
Presence of water bubbles
Presence of air bubbles
Classification of particles present in oil (ISO 4406 and NAS 1638) and
SAE AS 4059 (by referencing).

In summary, the OilWear sensor focuses on detecting wear and solid particles, providing crucial information about the mechanical integrity of the system and the presence of contaminants. At the same time, the YTS61 6-in-1 sensor is capable of analyzing a wide range of parameters, including viscosity, water content, temperature and other critical factors, as previously described.

The combination of different sensors can provide a more complete view of the condition of the compressor and the machinery or equipment in general. The focus of the present invention is the system as a whole, the sensors (which can be replaced by others with better precision and scope, depending on the application), the ML models that compose the AI tool for consuming data from oil sensors and other sensors of the monitored equipment and the other components of the system, such as, for example, the software for capturing and processing sensor data and the computational platform for indicating the results. Optionally, the AI tool can also consume oil analysis data in the laboratory.

The system of the present invention also comprises a web application server that displays intuitive dashboards, allowing users to view data, receive alerts and access detailed reports. The data is stored in a relational database. In addition, the data processing services organize the information, and the service comprises machine learning (ML) tools, performs inferences, stores and sends notifications to the web server, which shows the data visually and allows access to the history.

The method, system and panel of the present invention incorporate two AI tools, chained in series, with the aim of identifying the moment wherein the equipment is and, subsequently, its effective monitoring. As described below.

The first tool identifies the current state of the equipment 5.1, wherein the current state of the equipment comprises at least one of: off, on, turning on or turning off. This first tool 5.1 uses an AI tool, involving a machine learning model based on clustering. In addition, it uses a plurality of data from the equipment 1 and historical data of the equipment stored in a storage medium. The model related to the first tool to identify the current state of the equipment 5.1 employs dimensionality reduction by principal components (PCA, Principal Component Analysis) and probabilistic density estimation with a Kernel density estimator, providing accurate real-time information about the equipment.

The second tool identifies the operating condition of the equipment 5.2, wherein the operating condition of the equipment comprises one of: normal, satisfactory, unsatisfactory or unacceptable. The second tool comprises the use of AI tools.

In this sense, the second tool for identifying the operating condition of the equipment 5.2 is activated only when the equipment is not in the current state identified by the first tool 5.1, ensuring its operation during operation and contributing to proactive maintenance.

The second tool for identifying the operating condition of the equipment 5.2 comprises the use of data from multiple sources, including a plurality of oil quality data A, B and laboratory data to identify the operating condition of the equipment.

Furthermore, the second tool for identifying the operating condition of the equipment 5.2 comprises the use of a grouping-clustering algorithm based on DBSCAN (Density-Based Spatial Clustering of Applications with Noise). DBSCAN identifies clusters or groups of data from multiple sources that are densely populated in multidimensional space, where the groups represent different operating conditions of the equipment, i.e., at least one of: normal, satisfactory, unsatisfactory, or unacceptable. Specifically, DBSCAN groups metrics from data from multiple sources that exhibit similar behaviors over time. This may include, for example, metrics that tend to decrease in oil quality, indicating a possible correlation or functional dependence between them.

The result of DBSCAN clustering is a set of groups that represent different operating states or conditions of the equipment. Each cluster can be interpreted as an operating condition of the machine, such as: normal, satisfactory, unsatisfactory, or unacceptable.

Clusters are used as input to a machine learning classification model, trained with clusters representing the operating condition of the equipment to predict future events, such as the need for oil changes or maintenance, based on patterns identified by DBSCAN.

The training process of the machine learning classification model of the second tool to identify the operating condition 5.2 of the equipment comprises two main steps: clustering and classification.

In the first clustering step, the DBSCAN algorithm identifies densely populated data clusters in the multidimensional space, representing different operational states of the machine. These clusters are formed based on sensor metrics that exhibit similar behaviors over time. For example, metrics that tend to decrease in oil quality may indicate a possible correlation or functional dependency between them.

Once the clusters are identified, they serve as input to the machine learning classification model. This model is rigorously trained with a historical data set that includes information about the state of the equipment and past oil change or maintenance events. The model learns to recognize patterns and relationships between the clusters formed by DBSCAN and actual maintenance events. This allows the model to make more accurate predictions about the need for oil changes or maintenance based on the identified clusters.

It is important to note that the accuracy of the predictions is constantly refined as more data is collected and the model is regularly updated to adapt to new patterns of operation and equipment behavior. The second tool 5.2 is activated only when the equipment is not ‘off’, ensuring its operation during operation and contributing to proactive maintenance.

### Input Parameters

The following data are used from the input parameters of the industrial equipment:
actual opening data of the guide vanes,
engine power,
power on the output shaft of the equipment,
torque on the output shaft,
rotation of the output shaft,
rotation of the input shaft,
working oil level of the equipment,
working oil level of the vorecon,
differential of filter pressure of the lubricating oil,
pressure in the lubricating oil header,
pressure of the lubricating oil after the filter,
pressure of the lubricating oil after the pump,
temperature of the working oil after the exchanger,
temperature of the lubricating oil after the exchanger,
temperature of the lubricating oil downstream of the exchanger,
temperature of the lubricating oil in the tank,
temperature of the working oil of the torque converter,
temperature of the working oil downstream of the torque converter,
water detector in the equipment,
radial vibration x of the input shaft of the equipment,
radial vibration y of the input shaft of the equipment,
radial vibration x of the intermediate shaft of the equipment,
radial vibration y of the intermediate shaft of the equipment,
radial vibration x of the output shaft of the equipment,
radial vibration y of the output shaft of the equipment,
vibration of the casing on the low-speed side of the equipment,
vibration of the equipment on the high-speed side of the equipment,
axial displacement 1 of the input shaft of the equipment, and
axial displacement 2 of the input shaft of the equipment.

From the input parameters of at least one sensor, which may be an OilWear sensor, the following data are used:
Particle classification according to ISO 4406:1999/NAS 1638: This category includes the classification of particles in the oil, following the ISO 4406:1999 and NAS 1638 standards. This provides information to the model regarding the distribution and size of the particles, which is an important indicator of oil quality;
Total particles (P/ml): This metric represents the total particle count per milliliter of oil. The higher the count, the higher the particle concentration, which may be indicative of wear or contamination;
Air Bubble Detection & Discrimination & Counting (b/ml): This category involves the detection, discrimination and counting of air bubbles in the oil. The presence of air bubbles can affect system performance, and it is important to monitor this metric;
Shape recognition (p/ml): Shape recognition refers to the identification of different particle shapes in the oil, such as fatigue, sliding, cutting and others. This helps to identify the type of wear that is occurring in the equipment;
Oil Degradation (%): This metric indicates the level of oil degradation. As oil degrades over time, its physical and chemical properties change, which can affect equipment performance.

From the input parameters of the YTS61 6-in-1 sensor, the following data are used:
Density: Oil density, expressed in grams per cubic centimeter (g cm⁻³). Oil density can range from 0.6 g cm⁻³ to 1.25 g cm⁻³;
Viscosity: Viscosity is measured in millipascal seconds (mPa·s) or square millimeters per second (mm² s⁻¹). The viscosity range is from 25 to 400 mPa·s (or 500 mm² s⁻¹). Oil viscosity is an important indicator of its lubricating ability;
Dielectric Constant: This metric measures the dielectric constant of the oil, which can range from 1 to 6. The dielectric constant is relevant to assess the ability of the oil to insulate electricity;
Moisture Content (water dissolved in the oil): This metric represents the amount of moisture in the oil, measured in parts per million (ppm). The range is from 0 to 2000 ppm. Monitoring moisture is crucial to avoid oil degradation problems;
Water Activity: Water activity is a metric that ranges from 0 to 1 aw. It is related to the amount of water available in the oil and can affect its stability and performance;
Temperature: The sensor also provides information about the oil temperature, which can range from 0° C. to 100° C. Temperature is a critical factor in evaluating operating conditions.

### Output Data

Output data include indications of oil quality, labeled as: unacceptable, unsatisfactory, normal or satisfactory:
Unacceptable: Indicates that the lubricant has a severe change in some of the parameters analyzed. Need immediate action;
Unsatisfactory: Indicates that the lubricant has a moderate change in some of the parameters analyzed. Need technical analysis to define actions;
Satisfactory: Indicates that the lubricant has a small change in some of the parameters analyzed. Need technical analysis for possible application of actions;
Normal: Normal condition of use.

### Hyperparameters

The hyperparameters used in the model are:
a. Epsilon (ε): This hyperparameter defines the maximum neighborhood radius. It is used to determine the area within the algorithm searches for neighboring points. A point is considered part of a cluster if there is a minimum number of other points (defined by the second hyperparameter, MinPts) within this radius s. The value of ε is iterable between 0.2 and 50.
b. MinPts (Minimum Points): This hyperparameter defines the minimum number of points that must be found within the radius ε for a region to be considered dense, that is, for a point to be considered central within a cluster. If a point has fewer neighbors than MinPts within its radius ε, it is marked as noise or as an edge point, depending on whether it is completely isolated or not. The value of MinPts is also iterable between 2 E03 and 1 E04.

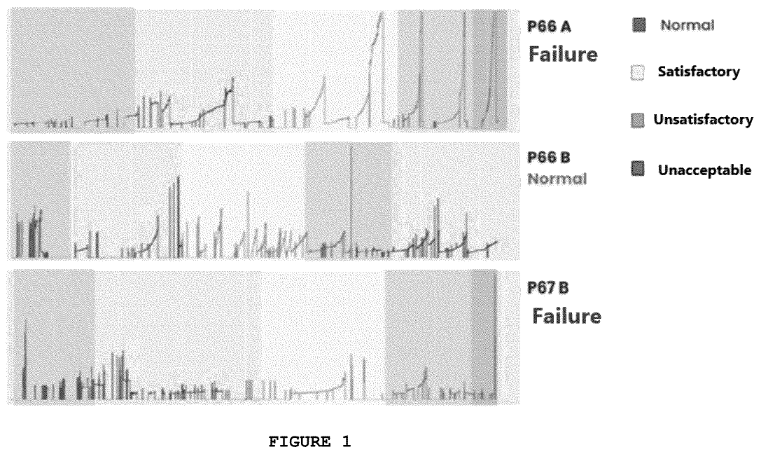

FIG. 1 illustrates the result of failure identification, using the method, system and panel of the present invention, in the torque converter bearing in two pieces of equipment, P66 A and P67 B, simultaneously, over the timeline. While equipment P66 B has no failure.

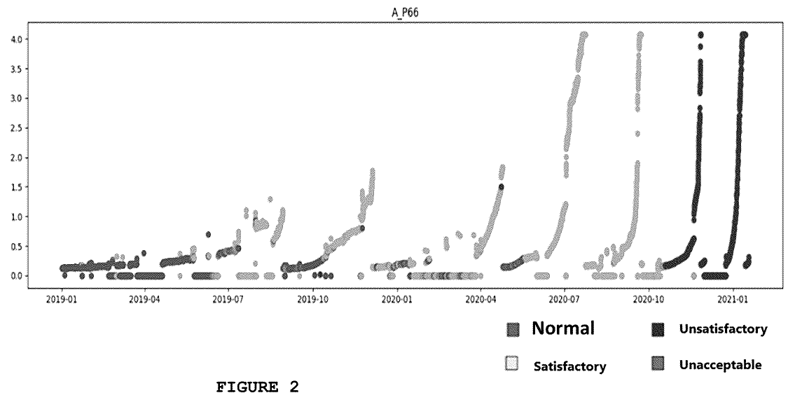

FIG. 2 illustrates the result of failure identification, using the method, system and panel of the present invention, in a single piece of equipment (A_P66) over the timeline.

### Detailed Description of the Steps of the Method for Monitoring the Condition of the Lubricating Oil of Industrial Equipment of the Present Invention

According to a preferred embodiment of the present invention, the method for monitoring the condition of the lubricating oil of industrial equipment comprises the steps of:
obtaining a plurality of data from equipment 1 and a plurality of oil quality data A, B;
identifying a current state of the equipment, where the current state of the equipment includes one of: off, on, turning on or turning off;
if the current state of the equipment is other than off, identifying the operational condition of the equipment, where the operational condition of the equipment includes one of: normal, satisfactory, unsatisfactory or unacceptable;
where the operational condition of the equipment is identified through a second tool to identify the operational condition of the equipment 5.2, which uses the DBSCAN (Density-Based Spatial Clustering of Applications with Noise) tool creating data groups from the plurality of oil quality data A, B where the data groups represent the operational condition of the equipment: normal, satisfactory, unsatisfactory or unacceptable;
feeding the equipment operational condition data groups into a machine learning classification model for predicting the condition of the lubricating oil of industrial equipment.

The plurality of data from equipment 1 is obtained through at least one equipment sensor 1, wherein the plurality of data from equipment 1 comprises:
actual opening data of the guide vanes,
engine power,
power on the output shaft of the equipment,
torque on the output shaft,
rotation of the output shaft,
rotation of the input shaft,
level of the working oil of the equipment,
level of the working oil of the vorecon,
differential of pressure of the lubricating oil filter,
pressure in the lubricating oil header,
pressure of the lubricating oil after the filter,
pressure of the lubricating oil after the pump,
temperature of the working oil after the exchanger,
temperature of the lubricating oil after the exchanger,
temperature of the lubricating oil downstream of the exchanger,
temperature of the lubricating oil in the tank,
working temperature of the oil of the torque converter equipment,
temperature of the working oil downstream of the torque converter,
water detector in the equipment,
radial vibration x of the input shaft of the equipment,
radial vibration y of the input shaft of the equipment,
radial vibration x of the intermediate shaft of the equipment,
radial vibration y of the intermediate shaft of the equipment,
radial vibration x of the output shaft of the equipment,
radial vibration y of the output shaft of the equipment,
vibration of the casing on the low-speed side of the equipment,
vibration of the equipment on the high-speed side of the equipment,
axial displacement 1 of the input shaft of the equipment, and
axial displacement 2 of the input shaft of the equipment.

The current state of the equipment is identified through a first tool to identify the current state of the equipment 5.1, which uses the dimensionality reduction tool by principal components (PCA, Principal Component Analysis) on the plurality of data of the equipment 1.

The plurality of oil quality data A, B is obtained through a plurality of oil quality sensors A, B, wherein the plurality of oil quality data A, B comprises:
Moisture
Density
Viscosity
Dielectric constant
Water activity and temperature
Density at 20° C.
Kinematic viscosity
Viscosity index
Viscosity at 40° C.
Viscosity at 100° C.
Particles in fluids (particle analysis)
Particle morphology
Presence of varnish
Degradation of fluid by opacity (level of coloration)
Presence of water bubbles
Presence of air bubbles
Classification of particles present in the oil (ISO 4406 and NAS 1638) and
SAE AS 4059 (by referencing).

The operating condition of the equipment is identified through the second tool to identify the operating condition of the equipment 5.2, using the DBSCAN (Density-Based Spatial Clustering of Applications with Noise) tool creating data groups from the plurality of data from the laboratory result of analysis of the lubricating oil of the equipment (4), wherein the data groups represent the operating condition of the equipment: normal, satisfactory, unsatisfactory or unacceptable.

### Detailed Description of the System for Monitoring the Condition of the Lubricating Oil of Industrial Equipment

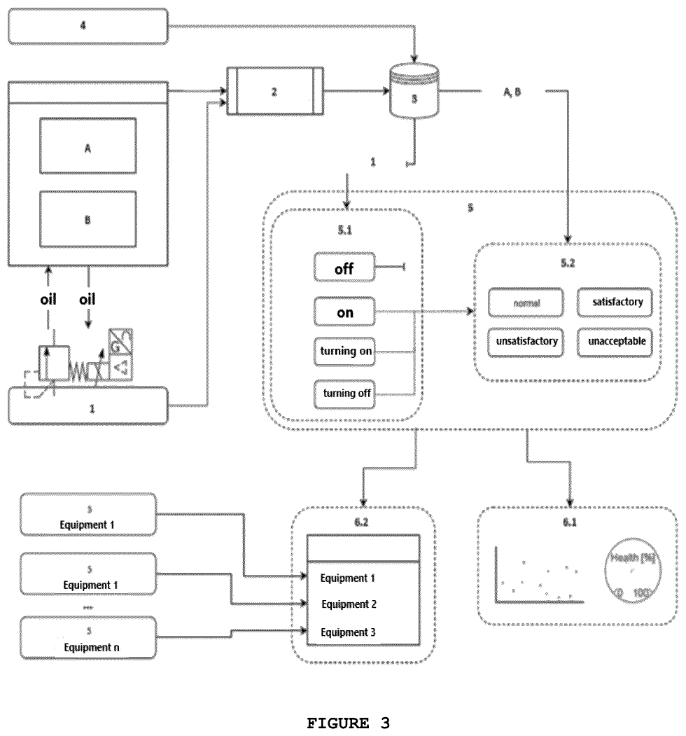

According to what is observed in FIG. 3, which presents a diagram that illustrates a preferred embodiment of the present invention, representing the system for monitoring the condition of the lubricating oil of industrial equipment comprising:
at least one equipment sensor 1;
a plurality of oil quality sensors A, B;
at least one data forwarding means 2;
at least one storage means 3;
at least one application server 5; and
at least one display means 6;
wherein the at least one application server 5 comprises a first tool for identifying the current state of the equipment 5.1 and a second tool for identifying the operating condition of the equipment 5.2;
wherein the at least one application server 5 performs prediction of the condition of the lubricating oil of industrial equipment.

### Equipment Sensor 1

In particular, the at least one equipment sensor 1 may provide a plurality of equipment sensor data 1, which may comprise:
actual opening data of the guide vanes,
engine power,
power on the output shaft of the equipment,
torque on the output shaft,
speed of the output shaft,
speed of the input shaft,
level of the working oil of the equipment,
level of the working oil of the vorecon,
differential of pressure of the lubricating oil filter,
pressure in the lubricating oil header,
pressure of the lubricating oil after the filter,
pressure of the lubricating oil after the pump,
temperature of the working oil after the exchanger,
temperature of the lubricating oil after the exchanger,
temperature of the lubricating oil downstream of the exchanger,
temperature of the lubricating oil in the tank,
working temperature of the oil of the torque converter equipment,
temperature of the working oil downstream of the torque converter,
water detector in the equipment,
radial vibration x of the input shaft of the equipment,
radial vibration y of the input shaft of the equipment,
radial vibration x of the intermediate shaft of the equipment,
radial vibration y of the intermediate shaft of the equipment,
radial vibration x of the output shaft of the equipment,
radial vibration y of the output shaft of the equipment,
casing vibration on the low-speed side of the equipment,
equipment vibration on the high-speed side of the equipment,
axial displacement 1 of the input shaft of the equipment, and
axial displacement 2 of the input shaft of the equipment.

### Oil Quality Sensors a, B

Furthermore, the plurality of oil quality sensors A, B may provide a plurality of oil quality data A, B comprising:
Moisture
Density
Viscosity
Dielectric constant
Water activity and temperature
Density at 20° C.
Kinematic viscosity
Viscosity index
Viscosity at 40° C.
Viscosity at 100° C.
Particles in fluids (particle analysis)
Particle morphology
Presence of varnish
Degradation of fluid by opacity (level of coloration)
Presence of water bubbles
Presence of air bubbles
Classification of particles present in the oil (ISO 4406 and NAS 1638) and
SAE AS 4059 (by referencing).

In particular, the plurality of oil quality sensors A, B may comprise at least one OilWear sensor from Atten2 Advanced Monitoring Technologies and YTS61 6-in-1 from Yateks or any other sensor available on the market or any other sensor complementary to these two, depending on the application.

### Data Forwarding Means 2

In particular, the at least one data forwarding means 2 comprises at least one router 2, wherein the router 2 may be configured with an embedded Linux operating system and serves as a central hub for data processing and routing. Furthermore, the at least one data forwarding means 2 aggregates data from the at least one equipment sensor 1 and the plurality of oil quality sensors A, B and forwards them to the at least one storage means 3, which may be a big data database 3, where they undergo storage and subsequent processing.

### Storage Medium 3

The at least one storage medium 3 comprises a data storage and management solution resulting from the integration of data from the plurality of equipment sensors 1, from the plurality of oil quality sensors A, B and data from the laboratory result of analysis of the lubricating oil of the equipment 4.

The aggregation of the adopted data represents the basis on which the analyses and modeling strategies are outlined.

The at least one storage medium 3 may be a computer-readable storage medium, which may be a memory, wherein the memory may be a non-volatile type, such as a hard disk drive (HDD) or a solid-state drive (SSD), or it may be a volatile memory, such as a random-access memory (RAM).

The readable storage medium may be any other medium or media that can transport or store or record an expected program code in the form of an instruction or a data structure or a set of instructions and can be accessed by one or more computers or one or more processors but is not limited to them. The readable storage medium may alternatively be a circuit or any other apparatus that can implement a storage or transport or recording function.

The at least one storage medium 3 comprises, stored therein, a set of computer-readable instructions, wherein when the set of computer-readable instructions is executed by one or more processors, the one or more processors implement the method for monitoring the condition of the lubricating oil of industrial equipment, as described above.

Specifically, the set of computer-readable instructions represents the algorithm or the computer program code or a data structure, which performs the method for monitoring the condition of the lubricating oil of industrial equipment of the present invention, described above.

The processor may be a general purpose processor, which may be a microprocessor or any conventional processor or similar.

### Application Server 5

The at least one application server 5 comprises the core of the intelligence of the system, the application server 5 being reserved for the operationalization of advanced AI models, intended for detailed data analysis.

In this sense, the at least one application server 5 comprises a first tool for identifying the current state of the equipment 5.1 and a second tool for identifying the operational condition of the equipment 5.2:
the first tool identifies the current state of the equipment 5.1, wherein the current state of the equipment comprises at least one of: off, on, turning on or turning off;
wherein the first tool identifies the current state of the equipment 5.1 comprises a machine learning model based on clustering; uses a plurality of data from the equipment 1 and historical data from the equipment stored in a storage medium, such as a big data database; employs dimensionality reduction by principal components (PCA, Principal Component Analysis) and estimation of probabilistic density with a Kernel density estimator;
the second tool identifies the operating condition of the equipment 5.2, where the operating condition of the equipment comprises at least one of: normal, satisfactory, unsatisfactory or unacceptable;
where the second tool to identify the operating condition of the equipment 5.2 is activated only when the equipment is not in the current state identified by the first tool identifies the current state of the equipment 5.1;
where the second tool to identify the operating condition of the equipment 5.2 comprises the use of data from multiple sources, including oil quality sensors and laboratory analyses; uses a grouping-clustering algorithm based on DBSCAN (Density-Based Spatial Clustering of Applications with Noise), where DBSCAN identifies groups in the data from multiple sources, where the groups represent the different operating conditions of the equipment, that is, at least one of: normal, satisfactory, unsatisfactory or unacceptable;
the data groups are fed as input to a machine learning classification model, trained to predict future events, such as the need for oil change or maintenance.

### Display Means 6.1, 6.2

The at least one display means 6.1 comprises at least one platform for showing analysis results relating to the current status of the equipment, operational condition of the equipment and predictions of possible failures, providing essential information to promote proactive maintenance. This display platform 6.1 can be found on an offshore vessel.

The at least one display means 6.2 comprises a platform for showing analysis results relating to all monitored assets, i.e. the equipment. With the aim of centralizing the data on a single platform, it provides essential information for promoting proactive maintenance and guiding strategic decisions, reaching the highest levels of coordination and governance. This display platform 6.2 can be found on an onshore vessel.

### Laboratory Data

Regarding the laboratory report data, it is worth noting that, in the process of evaluating and monitoring the condition of lubricating oil, laboratory data plays a complementary and not mandatory role. While online sensors provide a continuous and real-time evaluation, laboratory data are used to enrich this analysis, offering a more comprehensive and detailed view of the oil condition. Therefore, the integration of both data sets is essential for a complete and accurate evaluation of the quality of the lubricating oil and the condition of the equipment. Laboratory data are derived from detailed analyses of lubricating oil, and below are listed the main laboratory analytical methods and their protocols used to generate the input reports in the models.

### Karl Fischer/ASTM D6304

The Karl Fischer/ASTM D6304 analysis technique involves several steps. Initially, three portions of the sample are withdrawn and discarded using a syringe. Next, 100 μL of the sample is set aside, and the bubbles are removed, and the syringe and needle are cleaned externally with soft absorbent paper, eliminating excess sample. The syringe with the sample is then placed on the scale plate and is tared to find the actual weight, paying attention to the equipment deviation, which must be below 20 μg min⁻¹. If it is stable, press START again, insert the sample within 8 seconds through the silicone septum (used to seal vials with substances used in laboratories), aiming at the solution.

To change the value of the last analysis, simply click OK and enter the number found by the scale. The syringe is then returned to the scale, and the value is recorded on the Karl Fischer equipment. Press BACK and then START to start the sample analysis. At the end of the titration, the result of the water content in the sample is reported in % v/v and ppm.

### Water by Crackling/Noria Training Booklet Lubes Em Foco Magazine, Issue 46

The water analysis technique by crackling involves heating a metal plate to 160° C. and dripping two drops of oil onto the heated surface. The results are interpreted based on the observed visual and audible changes:
Absence of change indicates the absence of free or emulsified water.
Very small bubbles that disappear quickly indicate a water content between 500 ppm (0.05%) and 1000 ppm (0.1%).
Larger bubbles that join together and produce audible crackling and violent bubbling indicate a water content equal to or greater than 2000 ppm (0.2%).

The result of the sample analysis is reported based on these observed behaviors.

### Water and Oxidation by IR/Equipment Manual

The procedure begins with the MicroLab Software opening on the home screen of the computer, where the user adds his/her name and password and confirms by clicking on “Login”. After logging in, in the equipment program, the “Methods” option is selected and the sample to be analyzed is chosen. The “infrared” performs the background collection, which is done whenever the software is started or the method is changed.

Before collecting the background, it is important to clean the sensor and the crystal surface using isopropyl alcohol and a soft tissue or soft toilet paper. After cleaning and confirming the procedure sequence, the device automatically checks whether the crystal surface is adequately clean and ready for analysis.

With the crystal surface and sensor clean, the equipment asks the operator to place the sample in the center of the crystal and close the sensor in the appropriate position. The sample identification (ID) field is filled in with the corresponding identification. Wait until the equipment finishes reading the sample, which is displayed when it reaches 100%. The results are displayed, including information such as water content, oxidation (for hydraulic/compressor/turbine/gear lubricants), nitration, sulfation, soot, fuel content (for engine lubricating oils) and biodiesel (for Diesel).

The results are recorded on the analysis sheet and the sample reading procedure is finalized when “Complete” is confirmed.

### Color and Appearance/ASTM D1500; ASTM D1524

Separate the colorimeter, cuvette and color disks on the bench to perform the test, immediately after transferring a portion of the sample to the cuvette and placing it on the right side of the comparator kit. Fit the color disk with the numbering facing forward and position it in front of the hood light for better viewing. After placing the sample in front of the light, look through the viewer and turn the disc, looking for the color on the disc that is closest to the color of the sample. When the color is found, look in the hole for the value that refers to the sample value. If the sample does not have a similar color on the disc, the result will be unclassifiable: Due to the very dark color, above the equipment limit, greater than 8, it may be caused by contamination or aging. Or due to the turbidity of the sample, which may be caused by great contamination by water. Remove the device from the presence of light. Discard the sample in an appropriate place. Clean the cuvette at the end of the test. Save the material involved in the test. If the color of the sample is between two standards, report that the sample is less than the darker value, accompanied by the letter L. For example, if the sample is between 7 and 7.5, report L7.5 or <7.5. If the color of the sample is less than 0.5, the lowest value on the scale, report L0.5 or <0.5.

### Viscosity Determination/ASTM D445

In color and appearance analysis (ASTM D1500; ASTM D1524), a colorimeter, cuvette, and color disks are used. A portion of the sample is transferred to the cuvette, which is placed next to the comparator kit. The color disk is fitted and held in front of the light. The disk is rotated until the color closest to the sample is found and the corresponding value is recorded.

If the sample does not resemble any color on the disk, it is considered unclassifiable, possibly due to a very dark color or turbidity caused by contamination or aging. In this case, the sample is discarded.

After the test, the cuvette is cleaned and the material used is saved. If the color of the sample is between two standards, the sample is reported as less than the darker value, with the letter “L” preceding the value (e.g., L7.5 or <7.5). If the color of the sample is less than 0.5, it is reported as L0.5 or <0.5.

### Viscosity Index

The viscosity index is calculated based on the viscosities at 40° C. and 100° C. using the formula VI=(L−U/L−H)*100, where:
L is the viscosity at 40° C. of a reference oil with VI=0 and the same viscosity at 100° C. as the oil under study.
H is the viscosity at 40° C. of a reference oil with VI=100 and the same viscosity at 100° C. as the oil under study.
U is the viscosity at 40° C. of the oil under study.

The result is the viscosity index (VI) of the oil under analysis.

### TAN/ABNT NBR 14248:2009

The TAN (Total Acid Number) analysis is performed according to the ABNT NBR 14248:2009 standard. It involves the preparation of a KOH (potassium hydroxide) solution and the creation of a “bank” to record the volume used. In addition, a solution containing titration solvent and alpha-naphtholbenzene indicator is prepared.

The titration is performed with 0.01 N KOH until the turning point occurs, when the color of the sample changes. The volume used of 0.01 N KOH is recorded. The burette is then washed and filled with the 0.01 N KOH solution. The oil sample is added to the Erlenmeyer flask and titrated in the same way, with the volume used recorded.

The TAN value is calculated using a specific formula, taking into account the volumes of solution used and the mass of the sample. The result is expressed in mg KOH/g.

### Optical Particle Counting/ISO 4406-99 Equipment Manual

Optical particle counting analysis, according to ISO 4406-99, requires the preparation of specific materials and equipment. This includes a funnel, membranes, tweezers, an organizer box with dividers for the membranes and N-Hexane in the filter.

The procedure involves using the tweezers to pick up a membrane, which is washed with N-Hexane. The membrane is then placed over the funnel, screwing it over the membrane. The sample is shaken and placed in the funnel up to the 25 mL mark. A hose connected to a vacuum pump is connected to the funnel spout to suck the sample. N-Hexane is added to the sample to facilitate filtration.

After the sample has been completely sucked up, N-Hexane is used to remove excess oil from the walls of the funnel. The funnel is unscrewed and the membrane is removed with forceps, and then placed under a microscope for reading and classification, and stored in a suitable box. It is important to ensure that the microscope and surrounding area are clean before reading.

Reading is performed using a microscope at 100× magnification, where the membrane is classified according to ISO and NAS standards, along with the identification of contaminants, as described in the comparative manual.

### X-Ray Spectrometry/ASTM D4951

In the X-ray spectrometry technique, according to ASTM D4951, the preparation involves assembling an analysis cuvette with Mylar® Thin-Film CAT. NO.: 156-P01. The sample is added up to half the volume of the cuvette. Make sure to assemble the cuvette with the domed parts facing down, with the smaller part inside the larger one, pressing the Thin-film so that it is stretched and forms the bottom of the cuvette.

After assembling the cuvette, it is inserted into the equipment. The reading is performed using the corresponding software, and the results are reported in ppm.

### Varnish Analysis (MPC)/ASTM D7843

In the Varnish Analysis (MPC) according to ASTM D7843, the process includes the following steps:
1. Sample preparation, heating and storage.
2. Sample homogenization and filtration.
3. Determination of membrane color using the MPC device.

### Qualitative Analytical Ferrography/Equipment Manual; Training Booklet

In qualitative analytical ferrography analysis, the process involves preparing the ferrogram slide, which includes homogenizing the sample, using hexane, and reading it on the glass slide.

The data output is directly integrated into the Big Data Database, providing storage and reference viability for future instances.

### Examples and Results of the Invention

The system and method for automated, real-time monitoring of the condition of the lubricating oil of industrial equipment of the present invention can be applied to hydraulic units, machines, and equipment that have pressurized or non-pressurized lubricating oil in operation. In the case where the oil is non-pressurized, an electric pump is used to promote the flow of oil through the system.

Optionally, the automated, real-time monitoring system and method of the lubricating oil condition of industrial equipment of the present invention may be applied to equipment installed in areas at risk of explosion by placing the system inside a pressurized panel. The sensors of the system and the monitored equipment must be connected to a database server for storing measurements, processing these data through algorithms and showing the results of the monitoring process.

The automated, real-time monitoring system of the lubricating oil condition of industrial equipment of the present invention allows early identification of anomalies that may lead to failure. In the specific case of monitoring compressors with hydraulic variable speed drives, the system may detect:
Increased level of contaminants in the oil, which may cause premature wear of compressor parts, leading to production stoppages and high maintenance costs.
Oil degradation, which may lead to loss of compressor efficiency, reducing productivity and increasing energy consumption.
Water contamination, which can cause corrosion of compressor parts, resulting in production downtime and high maintenance costs.

Early identification of these anomalies allows corrective measures to be taken before failure occurs, avoiding production downtime, high maintenance costs and loss of productivity.

In addition, the system of the present invention can be used in more complex algorithms for monitoring the general condition of oil quality. These algorithms are capable of cross-referencing information on the condition of the oil with data obtained from other sensors, such as the operating condition of the machine, to detect anomalies that may result in operational downtime.

An example of an application of the system that is the object of this invention is the elimination of the gap in monitoring hydraulic variable speed drives of process gas compressors in the oil and gas industry.

Conventional online monitoring involves data from the original sensors of the equipment. The condition of the lubricating oil is monitored manually based on laboratory reports of oil samples collected periodically.

The oil and gas industry has a history of mechanical failures in this equipment without any warning being issued from the original monitoring techniques and it is believed that improving oil condition monitoring is essential to improve its overall protection, extending its useful life. In this sense, the installation of systems to incorporate the monitoring of physical-chemical parameters of the oil in line with pre-existing intellectual properties is not feasible, because the main problem identified in this equipment is the risk of varnish formation when it is operated under certain conditions, even within its operational envelope.

Since varnish formation is a process that is difficult to understand and monitor online, the approach proposed in this invention seeks, in this case, to provide the oil and gas industry with an effective monitoring system to preserve the mechanical integrity of this equipment.

### Panel for Monitoring the Condition of Lubricating Oil of Industrial Equipment

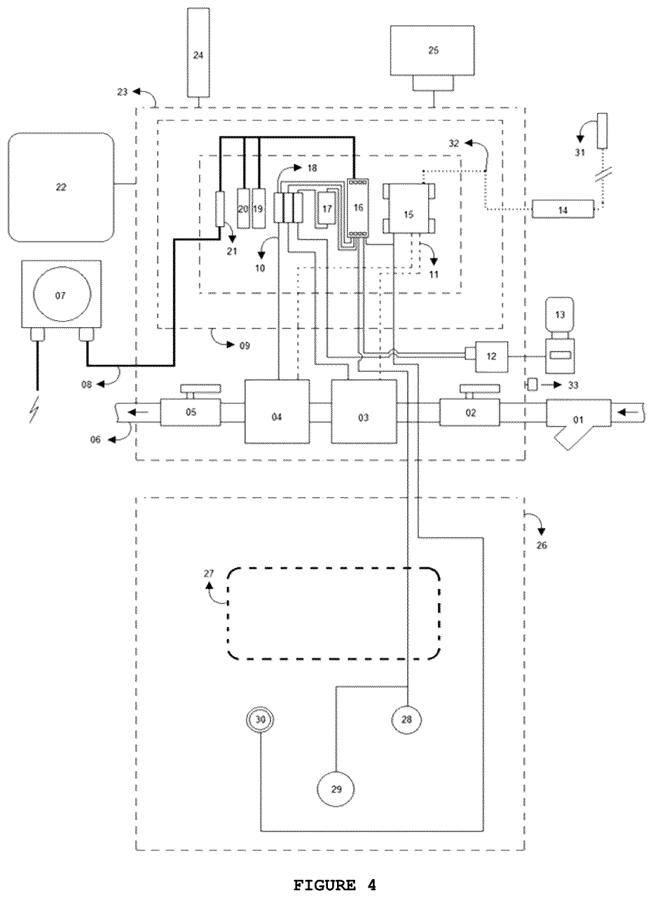

Furthermore, according to FIG. 4, the present invention also defines, according to another preferred embodiment thereof, a panel for monitoring the condition of lubricating oil of industrial equipment for a classified area, which comprises:
at least one filter 1,
at least one input register 2,
at least one first sensor 3,
at least one second sensor 4,
at least one output register 5,
at least one hydraulic pipe 6,
at least one general on/off switch 7,
at least one electrical cable 8,
at least one channel 9,
a plurality of power cables 10,
at least one data cable 11,
at least one actuating solenoid 12,
at least one vortex air inlet 13,
at least one sealing unit 14,
at least one router 15,
at least one source 16,
at least one thermostat 17,
at least one fuse 18,
at least one phase A surge protector 19,
at least one phase B surge protector 20,
at least one input circuit breaker 21,
at least one pressurizing unit 22,
at least one casing 23,
at least one vortex 24,
at least one purge valve 25,
at least one casing cover 26,
at least one glass display 27,
at least one indicator light 28,
at least one emergency button 29,
at least one router reset button 30,
at least one external antenna 31,
at least one antenna cable 32,
at least one grounding connector 33.

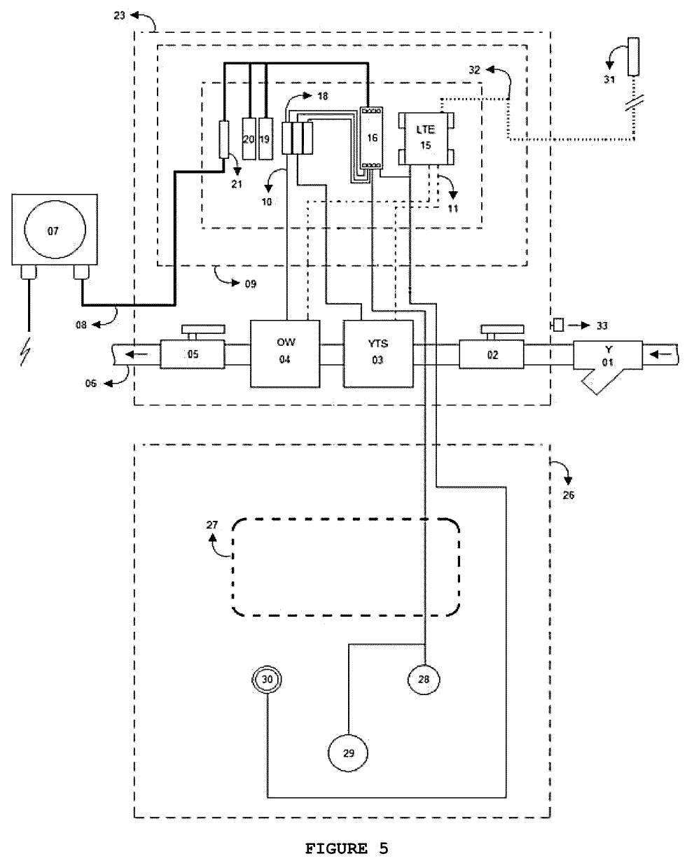

Additionally, according to FIG. 5, the present invention also defines, according to another preferred embodiment thereof, a panel for monitoring the condition of the lubricating oil of industrial equipment for a non-classified area, which comprises:
at least one filter 1,
at least one input register 2,
at least one first sensor 3,
at least one second sensor 4,
at least one output register 5,
at least one hydraulic pipe 6,
at least one general on/off switch 7,
at least one electrical cable 8,
at least one conduit 9,
a plurality of power cables 10,
at least one data cable 11,
at least one router 15,
at least one source 16,
at least one fuse 18,
at least one phase A surge protector 19,
at least one phase B surge protector 20,
at least one input circuit breaker 21,
at least one casing 23,
at least one casing cover 26,
at least one glass display 27,
at least one indicator light 28,
at least one emergency button 29,
at least one router reset button 30,
at least one external antenna 31,
at least one antenna cable 32,
at least one grounding connector 33.

In the panel for monitoring the condition of the lubricating oil of industrial equipment for a classified or non-classified area, the lubricating oil fluid, through the hydraulic piping (6), enters the filter (1) and its passage is regulated by the inlet valve (2). The lubricating oil then passes through the first sensor (3) and the second sensor (4), travels through the outlet valve (5) and returns to the industrial equipment system.

In the panel for monitoring the condition of lubricating oil of industrial equipment for a classified or non-classified area, the first sensor (3) and the second sensor (4) analyze the fluid, and the data generated by these sensors are collected and transmitted via router (15) to a data server, where they are stored, processed and showed on screens together with recommendations based on artificial intelligence models.

Specifically, the data server can be an application server 5, as previously described.

The panel for monitoring the condition of lubricating oil of industrial equipment for a classified or non-classified area is arranged inside a housing (23).

The panel for monitoring the condition of lubricating oil of industrial equipment for a classified area is pressurized for use of the equipment in potentially explosive areas.

In the panel for monitoring the condition of lubricating oil in industrial equipment for a classified or non-classified area, the reception of data by the panel for monitoring the condition of lubricating oil in industrial equipment is completely online, allowing access outside the environment/location where the industrial equipment to be analyzed is located.

In the panel for monitoring the condition of lubricating oil of industrial equipment for a classified or non-classified area, to ensure electrical safety, a main switch (7), located outside the casing (23), receives an electrical cable (8). Only then does the electrical cable (8) enter the casing (23), pass through the input circuit breaker (21), being protected by the phase A surge protector (19) and phase B surge protector (20), and is connected to the source (16). The source (16) is responsible for powering the router (15), the first sensor (3), the second sensor (3) and the actuating solenoid (12) through electrical cables (10).

In the panel for monitoring the condition of the lubricating oil of industrial equipment for a classified area, the actuating solenoid (12) is activated by the thermostat (17), upon identifying an increase in the internal temperature of the casing (23).

In the panel for monitoring the condition of the lubricating oil of industrial equipment for a classified or non-classified area, the information sent by the first sensor (3) and the second sensor (4) is transmitted through at least one data transfer cable (11), arranged inside the at least one housing (23) in at least one channel (9).

In the panel for monitoring the condition of the lubricating oil of industrial equipment for a classified or non-classified area, the cover (26) of the casing (23) includes a display (27) to observe whether the internal components are in operation (any light on). The casing (23) also houses at least one emergency button (29), at least one router (15) reset button (30) and at least one indicator light (28), which signals when the panel is energized.

In the panel for monitoring the condition of the lubricating oil of industrial equipment for a classified area, at least one pressurizing unit (22) and at least one purge valve (25) are responsible for keeping the casing (23) under pressure, ensuring that no gas enters the casing (23). Furthermore, at least one vortex air inlet (13), the actuating solenoid (12) and at least one vortex (24) are responsible for keeping the inside of the casing (23) cooled, through the automatic activation of the thermostat (17). The thermostat (17), the first sensor (3) and the second sensor (4) are connected and protected by at least one fuse (18) in order to avoid damage in the event of a surge or overload.

In the panel for monitoring the condition of lubricating oil of industrial equipment for a non-classified area, the first sensor (3) and the second sensor (4) are connected and protected by at least one fuse (18) so as to prevent damage in the event of a surge or overload.

Furthermore, in the panel for monitoring the condition of lubricating oil of industrial equipment for a classified area, at least one sealing unit (14) is required for the input of at least one external antenna (31) that connects to the router (15) via at least one antenna cable (32). This sealing unit (14) insulates the cable in the casing (23), preventing pressurized air from escaping through the input of the antenna cable (32).

The panel for monitoring the condition of lubricating oil of industrial equipment for a non-classified area comprises at least one external antenna (31) that connects to the router (15) via at least one antenna cable (32).

In the panel for monitoring the condition of the lubricating oil of industrial equipment for a classified or non-classified area, the casing (23) and its components are grounded by means of at least one grounding connector (33) to prevent accumulation of charges, electrical surges and even atmospheric discharges from causing the equipment to burn out.

Those skilled in the art will appreciate the knowledge shown herein and will be able to reproduce the invention in the indicated embodiments and in other variants.

1. A method for monitoring the condition of the lubricating oil of industrial equipment, comprising the steps of:
obtaining a plurality of equipment data, a plurality of oil quality data and a plurality of data from the laboratory result of analysis of the lubricating oil of the equipment;
identifying a current state of the equipment, wherein the current state of the equipment includes one of: off, on, turning on or off;
if the current state of the equipment is other than off, identifying the operational condition of the equipment, wherein the operational condition of the equipment includes one of: normal, satisfactory, unsatisfactory or unacceptable;
wherein the operational condition of the equipment is identified through a tool to identify the operational condition of the equipment, using the Density-Based Spatial Clustering of Applications with Noise (DBSCAN) tool, creating data groups from the plurality of oil quality data, wherein the data groups represent the operational condition of the equipment: normal, satisfactory, unsatisfactory or unacceptable;
feeding the equipment operational condition data groups into a machine learning classification model for predicting the condition of lubricating oil of industrial equipment.

2. The method, according to claim 1, wherein the plurality of equipment data is obtained through at least one equipment sensor, wherein the plurality of equipment data comprises:
actual opening data of the guide vanes,
engine power,
power on the output shaft of the equipment,
torque on the output shaft,
rotation of the output shaft,
rotation of the input shaft,
level of the equipment working oil,
level of the working oil,
pressure differential of the lubricating oil filter,
pressure in the lubricating oil header,
pressure of the lubricating oil after the filter,
pressure of the lubricating oil after the pump,
temperature of the working oil after the exchanger,
temperature of the lubricating oil after the exchanger,
temperature of the lubricating oil downstream of the exchanger,
temperature of the lubricating oil in the tank,
working temperature of the oil of the torque converter equipment,
temperature of the working oil downstream of the torque converter,
water detector in the equipment,
radial vibration x of the equipment input shaft,
radial vibration y of the equipment input shaft,
radial vibration x of the equipment intermediate shaft,
radial vibration y of the equipment intermediate shaft,
radial vibration x of the equipment output shaft,
radial vibration y of the equipment output shaft,
vibration of the casing on the low-speed side of the equipment,
vibration of the equipment on the high-speed side of the equipment,
axial displacement 1 of the input shaft of the equipment, and
axial displacement 2 of the input shaft of the equipment.

3. The method, according to claim 1, wherein the current state of the equipment is identified through a tool for identifying the current state of the equipment, which uses the dimensionality reduction tool by principal components (PCA, Principal Component Analysis) in the plurality of equipment data.

4. The method, according to claim 1, wherein the plurality of oil quality data is obtained through a plurality of oil quality sensors, wherein the plurality of oil quality data comprises:
moisture,
density,
viscosity,
dielectric constant,
water activity and temperature,
density at 20° C.,
kinematic viscosity,
viscosity index,
viscosity at 40° C.,
viscosity at 100° C.,
particles in fluids (particle analysis),
particle morphology,
presence of varnish,
degradation of fluid by opacity (level of coloration),
presence of water bubbles,
presence of air bubbles,
classification of particles present in the oil, and
evaluation of the level of contamination by counting particles in 100 mL.

5. The method, according to claim 1, wherein the operational condition of the equipment is identified through the tool for identifying the operating condition of the equipment, using the DBSCAN tool, creating data groups from the plurality of data from the laboratory result of analysis of the lubricating oil of the equipment, wherein the data groups represent the operating condition of the equipment: normal, satisfactory, unsatisfactory or unacceptable.

6. A system for monitoring the condition of lubricating oil of industrial equipment, comprising:
at least one equipment sensor;
a plurality of oil quality sensors;
at least one data forwarding means;
at least one storage means;
at least one application server; and
at least one display means;
wherein the at least one application server comprises a first tool for identifying the current status of the equipment and a second tool for identifying the operational condition of the equipment;
wherein the at least one application server performs prediction of the condition of the lubricating oil of industrial equipment.

7. The system, according to claim 6, wherein the at least one equipment sensor provides a plurality of equipment data, comprising:
actual opening data of the guide vanes,
engine power,
power on the output shaft of the equipment,
torque on the output shaft,
rotation of the output shaft,
rotation of the input shaft,
level of the working oil of the equipment,
level of the working oil,
pressure differential of the lubricating oil filter,
pressure in the lubricating oil header,
pressure of the lubricating oil after the filter,
pressure of the lubricating oil after the pump,
temperature of the working oil after the exchanger,
temperature of the lubricating oil after the exchanger,
temperature of the lubricating oil downstream of the exchanger,
temperature of the lubricating oil in the tank,
working temperature of the oil of the torque converter equipment,
temperature of the working oil downstream of the torque converter,
water detector in the equipment,
radial vibration x of the input shaft of the equipment,
radial vibration y of the input shaft of the equipment,
radial vibration x of the intermediate shaft of the equipment,
radial vibration y of the intermediate shaft of the equipment,
radial vibration x of the output shaft of the equipment,
radial vibration y of the output shaft of the equipment,
vibration of the casing on the low-speed side of the equipment,
vibration of the equipment on the high-speed side of the equipment,
axial displacement 1 of the input shaft of the equipment, and
axial displacement 2 of the input shaft of the equipment.

8. The system, according to claim 6, wherein the plurality of oil quality sensors provide a plurality of oil quality data comprising:
moisture,
density,
viscosity,
dielectric constant,
water activity and temperature,
density at 20° C.,
kinematic viscosity,
viscosity index,
viscosity at 40° C.,
viscosity at 100° C.,
particles in fluids (particle analysis),
particle morphology,
presence of varnish,
degradation of the fluid due to opacity (level of coloration),
presence of water bubbles,
presence of air bubbles,
classification of particles present in the oil, and
evaluation of the level of contamination by counting particles in 100 mL.

9. The system, according to claim 6, wherein the at least one data forwarding means comprises at least one router that aggregates data from the at least one equipment sensor and data from the plurality of oil quality sensors and forwards them to the at least one storage means.

10. The system, according to claim 6, wherein the at least one storage medium receives a plurality of data from the laboratory result of analysis of the lubricating oil of the equipment, a plurality of equipment data and a plurality of oil quality data.

11. The system, according to claim 6, wherein:
the first tool identifies the current state of the equipment, using the dimensionality reduction tool by principal components (PCA, Principal Component Analysis) in a plurality of equipment data, wherein the current state of the equipment comprises: off, on, turning on or turning off; and/or
the second tool for identifying the operational condition of the equipment identifies an operational condition of the equipment using the DBSCAN tool, creating data groups from a plurality of data from the laboratory result of analysis of the lubricating oil of the equipment, wherein the data groups represent the operational condition of the equipment: normal, satisfactory, unsatisfactory or unacceptable.

12. The system, according to claim 11, wherein the at least one application server predicts the condition of the lubricating oil of industrial equipment by feeding the data groups on the operational condition of the equipment into a machine learning classification model for predicting the condition of the lubricating oil of industrial equipment.

13. A panel for monitoring the condition of the lubricating oil of industrial equipment, comprising:
at least one filter,
at least one first sensor,
at least one second sensor,
at least one outlet register, and
at least one hydraulic pipe,
wherein the lubricating oil from the industrial equipment enters the at least one filter and, through the at least one hydraulic pipe, passes through the first sensor and the second sensor, up to the at least one outlet register and returns to the industrial equipment;
the data generated by the first sensor and the second sensor are transmitted via the at least one router to a data server, which stores a set of instructions for carrying out the method as defined in claim 1.

14. A panel, according to claim 13, wherein:
the panel is arranged in at least one casing, optional wherein the casing further comprises at least one cover, which includes at least one display, at least one indicator light, at least one emergency button, and at least one router reset button; and/or
the data generated by the first sensor and by the second sensor are transmitted via the at least one router through at least one data cable, in at least one channel.

15. The panel, according to claim 13, wherein the panel is arranged in at least one casing, wherein the panel is pressurized through at least one pressurizing unit and at least one purge valve;
wherein the casing comprises at least one vortex air inlet, at least one vortex and at least one actuating solenoid, which is connected to at least one source through a plurality of power cables;
wherein the actuating solenoid is actuated by at least one thermostat, upon identifying an increase in internal temperature of the at least one casing.

16. The panel, according to claim 14, further comprising:
at least one general switch arranged on the outside of the at least one casing, wherein the at least one general switch is connected via at least one electrical cable to at least one input circuit breaker, which is connected to the at least one phase A surge protector and at least one phase B surge protector, which are connected to at least one source.

17. The panel, according to claim 16, wherein the at least one source is connected to the at least one first sensor, to the at least one second sensor, to the at least one router, via a plurality of power cables.

18. The panel, according to claim 13, further comprising:
at least one input register for regulating the passage of lubricating oil through at least one hydraulic pipe;
at least one fuse connected to at least one first sensor, to at least one second sensor;
at least one antenna, wherein at least one cable of the antenna connects to at least one router; and
at least one grounding connector.

19. The panel, according to claim 13, further comprising:
at least one input register for regulating the passage of lubricating oil through at least one hydraulic pipe;
at least one fuse connected to at least one first sensor, to at least one second sensor and to at least one thermostat;
at least one sealing unit with at least one antenna connected thereto, wherein the at least one cable of the antenna connects to at least one router; and
at least one grounding connector.

20. A computer-readable storage medium, comprising, stored therein, a set of computer-readable instructions which, when executed by a computer, perform the method as defined in claim 1.
